(19) United States
(12) Patent Application Publication
(10) Pub. No.: US 2020/0166428 A1
(43) Pub. Date: May 28, 2020

(54) ROAD DAMAGE CALCULATION SYSTEM, ROAD DAMAGE CALCULATION METHOD, AND NON-TRANSITORY RECORDING MEDIUM STORING ROAD DAMAGE CALCULATION PROGRAM

(71) Applicant: KONICA MINOLTA, INC., Tokyo (JP)

(72) Inventors: Asahi EBE, Tokyo (JP); Takayuki DOUI, Tokyo (JP); Shinichi IIZUKA, Fukushima-shi (JP); Tetsuo HIRATA, Tokyo (JP); Masashi AOKI, Tokyo (JP); Tadaaki SUMITANI, Tokyo (JP)

(21) Appl. No.: 16/694,084

(22) Filed: Nov. 25, 2019

(30) Foreign Application Priority Data
Nov. 26, 2018 (JP) 2018-220716

(51) Int. Cl. G01M 5/00; G01G 19/03

(52) U.S. Cl. CPC G01M 5/0033; G01G 19/03

(57) ABSTRACT

A road damage calculation system of the present invention includes a load detector that detects a load applied to a road from a vehicle on the road, and a server including a hardware processor that calculates road damage from the load obtained by the load detector and accumulates the calculated road damage to calculate accumulated road damage.

### CROSS-REFERENCE TO RELATED APPLICATION

The present invention claims priority under 35 U.S.C. § 119 to Japanese patent application No. 2018-220716 filed on Nov. 26, 2018, the entire contents of which are incorporated herein by reference.

### BACKGROUND

### 1. Technological Field

The present invention relates to a road damage calculation system, a road damage calculation method, and a non-transitory recording medium storing a road damage calculation program.

### 2. Description of the Related Art

In recent years, age deterioration of roads has been a social issue, and it is estimated that road repairs cost four trillion yen or more. Thus, avoiding waste in the use of road repairing cost and efficient management are required. Thus, for example, as described in JP 2005-115678 A, a road maintenance support system for grasping the condition of a road and making an appropriate repair plan has been proposed.

The above road maintenance support system includes a repair/inspection plan creation device which forms a repair/inspection plan of a road and an inspection terminal mounted on a vehicle. The repair/inspection plan creation device creates an inspection plan on the basis of inspection histories in the past recorded in a recording device and transmits the created inspection plan to the inspection terminal. The inspection terminal performs an inspection of a deterioration state of a road on the basis of the inspection plan using a camera, microphone, an acoustic sensor, and a vibration sensor which are mounted on the inspection terminal and transmits the inspection result to the repair/inspection plan creation device. The repair/inspection plan creation device classifies the degree of the deterioration of the road, estimates a deterioration tendency of the road in the future, and provides a plurality of repair plan ideas relating to a repair location, a repair timing, and a repair scale on the basis of the inspection result. Accordingly, a road administrator finally selects one of the repair plans, a rule relating to a construction process, equipment, and staff arrangements for achieving the selected repair plan is extracted from database, and a road repair execution navigation is performed to the road administrator.

### SUMMARY

However, the conventional technology performs the inspection of the road condition by causing a vehicle equipped with the inspection terminal (inspection vehicle) to travel. Thus, although a deterioration state at the point in time when the inspection vehicle is caused to travel can be obtained, it is not possible to know the degree of damage applied to the road.

Thus, it is an object of the present invention to provide a road damage calculation system, a road damage calculation method, and a non-transitory recording medium storing a road damage calculation program capable of grasping damage applied to a road.

To achieve at least one of the abovementioned objects, according to an aspect of the present invention, a road damage calculation system reflecting one aspect of the present invention comprises a load detector that detects a load applied to a road from a vehicle on the road; and a controller that calculates road damage from the load obtained by the load detector, and accumulates the calculated road damage to calculate accumulated road damage.

Moreover, to achieve the above-mentioned object, according to an aspect of the present invention, a road damage calculation method reflecting one aspect of the present invention includes (a) detecting a load applied to a road from a vehicle on the road; (b) calculating road damage from the detected load; and (c) accumulating the calculated road damage to calculate accumulated road damage.

Moreover, to achieve the above-mentioned object, according to an aspect of the present invention, a non-transitory recording medium reflecting one aspect of the present invention stores a computer readable program for causing a computer to perform a road damage calculation method including (a) detecting a load applied to a road from a vehicle on the road; (b) calculating road damage from the detected load; and (c) accumulating the calculated road damage to calculate accumulated road damage.

The objects, features, and characteristics of this invention other than those set forth above will become apparent from the description given herein below with reference to preferred embodiments illustrated in the accompanying drawings.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram illustrating the configuration of a road damage calculation system according to an embodiment using the present invention.

FIG. 2 is an explanatory diagram explaining an installation example of axle load meters.

FIG. 3 is an explanatory diagram explaining an installation example of the axle load meters.

FIG. 4 is an explanatory diagram explaining an installation example of then axle load meters.

FIG. 5 is a diagram illustrating an example of an environment coefficient based on temperature and humidity.

FIG. 6 is a graph of the number of passing vehicles in each year in a route A in FIG. 2.

FIG. 7 is a diagram illustrating an original repair plan and a road life calculated by the present embodiment.

FIG. 8 is a flowchart illustrating a procedure for road damage calculation.

FIG. 9 is a flowchart illustrating a procedure for road damage control.

FIG. 10 is a bird's-eye view illustrating an installation state of a contactless axle load meter used in the present embodiment.

FIG. 11 is a block diagram illustrating the functional configuration of the contactless axle load meter.

FIG. 12 is a graph illustrating the correspondence relationship between a deformation amount of a tire and an axle load of a vehicle.

FIG. 13A and FIG. 13B are explanatory diagrams explaining an apparent shape of a tire T of which image is captured.

FIG. 14A and FIG. 14B are explanatory diagrams explaining calculation of the deformation amount of the tire T.

FIG. 15 is a flowchart illustrating a procedure of axle load calculation and overloading detection which are executed in a processing device of the contactless axle load meter.

FIG. 16A and FIG. 16B are explanatory diagrams explaining identification of the distance between an imaging surface and the tire T of which image is to be captured.

FIG. 17A and FIG. 17B are explanatory diagrams explaining another method relating to the identification of the distance between the imaging surface and the tire T of which image is to be captured.

FIG. 18 is a diagram illustrating a modification of the contactless axle load meter.

### DETAILED DESCRIPTION OF EMBODIMENTS

Hereinafter, an embodiment of the present invention will be described in detail with reference to the drawings. Note that, in the description of the drawings, the same elements are denoted by the same reference numerals, and redundant description is omitted. In addition, in some cases, dimensional ratios in the drawings are exaggerated and different from actual ratios for convenience of the description.

(Road Damage Calculation System)

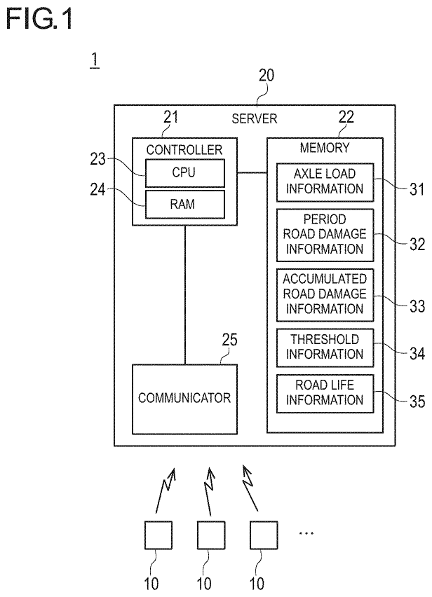

FIG. 1 is a schematic diagram illustrating the configuration of a road damage calculation system according to an embodiment using the present invention.

A road damage calculation system 1 includes a plurality of axle load meters 10 and a server 20.

The axle load meter 10 is a load detector for detecting a load applied to a road from a vehicle on the road, and a contactless axle load meter that contactlessly measures an axle load of a vehicle is used in the present embodiment. Details of the contactless axle load meter will be described later.

The axle load meter 10 transmits the measured axle load of the vehicle as axle load information to the server 20. The axle load information is information of a load applied to the road by the vehicle traveling on the road. The axle load meter 10 is installed in a necessary location in a road network within the jurisdiction. Thus, a plurality of axle load meters 10 are connected to one server.

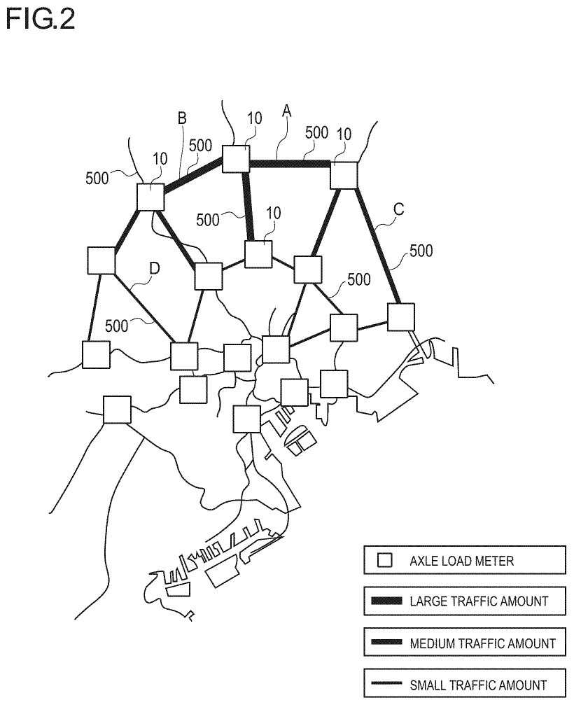

FIG. 2 to FIG. 4 are explanatory diagrams explaining installation examples of the axle load meters.

FIG. 2 is an example in which the axle load meters are installed in an expressway network in an urban area. As illustrated, the axle load meter 10 is installed in each of ETC (Electronic Toll Collection System) lanes that are present at entrances and exits of an expressway 500. Accordingly, the axle load of a vehicle passing through the ETC lane can be measured. Further, in the case of the expressway 500, the axle load meter 10 is preferably installed also in a tollgate lane with no ETC.

Installing the axle load meters 10 at the entrances and the exits of the expressway 500 in this manner makes it possible to grasp road damage of each road (route) between the entrance and the exit and make a repair plan based on the road damage.

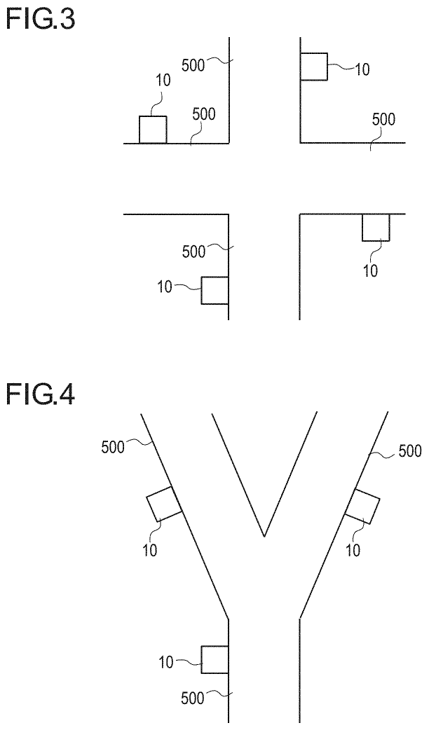

FIG. 3 is an example in which the axle load meters are installed at an intersection (crossroads). The axle load meter 10 is installed in each of all intersecting roads 500. At the intersection, the type of passing vehicles and the amount of traffic tend to be substantially the same between the intersecting roads 500 in some cases, but differ between the roads 500, such as an arterial road and a road intersecting the arterial road, in some cases. In the present embodiment, installing the axle load meters 10 in the respective intersecting roads 500 makes it possible to grasp road damage of each of the intersecting roads 500 and make a repair plan based on the road damage.

FIG. 4 is an example in which the axle load meters are installed at a road branch point. Also in the case of the road branch point, the axle load meter 10 is installed in each of branching roads 500. Accordingly, in the present embodiment, it is possible to grasp road damage of each of the branching roads 500 and make a repair plan based on the road damage in a manner similar to the intersection.

Referring back to FIG. 1, description will be continued.

The server 20 is a computer that performs an arithmetic process, and includes a controller 21, a memory 22, and a communicator 25.

The controller 21 is a processor that controls the operation of the server 20 in a centralized manner. The controller 21 includes a CPU (Central Processing Unit:) (a hardware processor) 23 that performs various arithmetic processes, a RAM (Random Access Memory) 24 that provides the CPU 23 with a memory space for operation and temporarily stores data, and the like. Further, the controller 21 performs arithmetic processes for calculation of road damage, calculation of a road life, and output of information about a traffic regulation (described later). Further, the controller 21 performs an arithmetic process for forming (or correcting) a repair plan based on a road life.

The memory 22 stores various programs, acquired information, a calculated result, and the like. In particular, in the present embodiment, the memory 22 stores axle load information 31, period road damage information 32, accumulated road damage information 33, threshold information 34, and road life information 35.

The axle load information 31 is information of an axle load acquired from the axle load meter 10. The period road damage information 32 is information of road damage for a predetermined period. The accumulated road damage information 33 is information obtained by sequentially accumulating calculated road damage. The threshold information 34 is information of an allowable total road damage amount that is determined on the basis of a repair plan. The road life information 35 is information of a period after which a repair becomes required, which is obtained on the basis of the period road damage information 32, the accumulated road damage information 33, and the threshold information 34.

For example, a nonvolatile memory such as a rewritable flash memory, an HDD (Hard Disk Drive), or the like can be used as the memory 22 as described above. Further, the programs, initial setting data, and the like may be stored in a mask ROM or the like. Further, temporary storage may be performed in the RAM 24.

The programs stored herein are programs for causing the server 20 (which is a computer) to execute a procedure (described later). In the present embodiment, the programs include a program of calculation of damage applied to a road and road life calculation based on the damage, a program of road damage control for extending the obtained road life, a program for forming a repair plan, and the like. The CPU 23 of the controller 21 reads the programs and the setting data from the memory 22, causes the RAM 24 to store the read programs and setting data, and executes the programs.

The communicator 25 performs communication with an external device. Here, the communicator 25 performs wireless communication with the axle load meter 10 and also performs wireless communication and wired communication with another computer and the like. The axle load meter 10 is installed in various roads in a wide area. Thus, the communicator 25 preferably uses, for example, communication by portable wireless technology that can cover a wide area. Further, the communicator 25 can use not only the portable wireless technology, but also communication technologies such as the Ethernet (registered trademark) and the Internet, and these communication technologies may be, for example, wireless communication technologies using WiFi and a dedicated line. Further, the communicator 25 may use not only wireless communication, but also a wired communication technology.

(Road Damage Calculation Method)

Next, a road damage calculation method by the above road damage calculation system will be described.

In the present embodiment, as already described, the axle load meter 10 is provided for each road to be managed. The axle load meter 10 measures the weight of each axle of a vehicle (referred to as the axle load). The axle load is a load directly applied to the road and directly linked to road damage applied to the road by the passage of the vehicle. In the present embodiment, since the axle load is measured, it is not necessary to measure the total weight of the vehicle.

The axle load measured by the axle load meter 10 is transmitted to the controller 21 and temporarily stored as the axle load information 31 in the memory 22. The controller 21 calculates road damage using the axle load information 31.

The road damage is calculated on the basis of the load applied to the road from the vehicle on the road using the following Equation (1).

road damage=(load\hat{ }a)*coefficient (1)

Accumulated road damage is obtained by accumulating the road damage (described in detail later) and calculated using the following Equation (2).

accumulated road damage=Σroad damage=Σ((load\hat{ }a)*coefficient) (2)

(Note that, in Equations (1) and (2), the constant a is a value for calculating damage applied to the road by the load, and the coefficient is a value affecting the road damage and at least one of an environment coefficient based on temperature and/or humidity, an age coefficient based on aging of the road, a structure coefficient based on a construction structure of the road, and a material coefficient based on a material of the road (described in detail later).

In order for the controller 21 to obtain the road damage from the axle load using such an equation, the road damage is calculated using the following Equation (1A) in which the axle load is applied to the above Equation (1).

road damage=(axle load\hat{ }a)*coefficient (1A)

In Equation (1A), the constant a is a value for calculating damage applied to the road by the axle load. For example, in an announcement by the Ministry of Land, Infrastructure, Transport and Tourism, the influence of the weight of a vehicle on fatigue of a road structure is the 4th power of the weight in a pavement and the 12th power of the weight in a reinforced concrete floor slab (the Ministry of Land, Infrastructure, Transport and Tourism “Optimization Policy for Passage of Large-sized Vehicle for Measures against Road Age Deterioration”, Document 2 <First Kanto Liaison Meeting for Large-sized Vehicle Passage Optimization> Jan. 29, 2016, P. 6, “1. Present Situation of Road Age Deterioration”, URL=http://www.ktr.mlit.go.jp/ktr_content/content/000641190.pdf). Further, the influence on deterioration of a road bridge is also the 12th power of the weight of a vehicle (the Ministry of Land, Infrastructure, Transport and Tourism, Partial Change of “Restriction of Passage of Vehicle” or the like, Feb. 23, 2015, P. 3, URL=http://www.ktr.mlit.go.jp/ktr_content/content/000641197.pdf).

Thus, when the road damage is calculated using Equation (1A), a=4 in a paved road, and a=12 in a reinforced concrete floor slab and a road bridge. Of course, alternatively, the constant a may be a value other than these values according to the structure, the material, and the like of the road.

The coefficient of Equation (1A) is a value affecting the road damage and, for example, at least one of an environment coefficient based on temperature and/or humidity, an age coefficient based on aging of the road, a structure coefficient based on a construction structure of the road, a material coefficient based on a material of the road, and traveling information based on a tire type, a tire deterioration degree, a vehicle speed, and acceleration. Actual calculation is performed using any one or more of these coefficients according to a road environment, years of use, and the like. When a road environment is severe, for example, since Japan has the four seasons and has an area where changes in temperature and humidity are drastic, the road damage can be more precisely calculated in such an area by using the environment coefficient. Further, as for aging, since the influence of the lapse of time on a road is small when not many years have passed after the completion of the road, the age coefficient may not be required (or set to 1). However, when many years have passed after the completion of the road, the influence of the lapse of time increases. Thus, the road damage can be more precisely calculated by using the age coefficient. In addition, the structure coefficient is a value varying according to the construction structure of the road and varying according to whether the road is structurally resistant to damage. The material coefficient is a value varying according to whether the material used in the road is resistant to damage. The traveling information is a value based on how the tire type, the tire deterioration degree, the vehicle speed, and the acceleration of the vehicle of which axle load has been measured affect the road. The tire type, the tire deterioration degree, the vehicle speed, and the acceleration are detected from a captured image captured by a camera of a contactless axle load meter (described later).

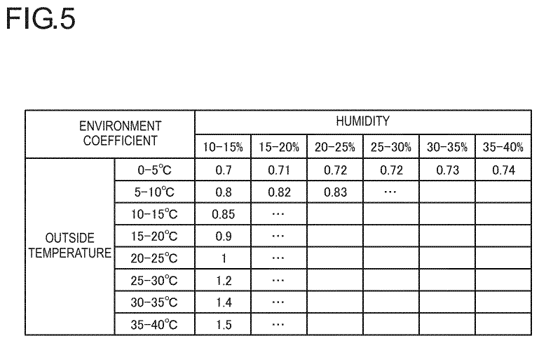

An example will be described. FIG. 5 is a diagram illustrating an example of the environment coefficient based on temperature and humidity.

For example, as illustrated in FIG. 5, as the environment coefficient, the relationship between the temperature (outside air temperature) and humidity and the influence on the road is stored as table data in the memory 22. Such table data is previously obtained by an experiment (may be an acceleration test) or the like. On the other hand, a temperature sensor and a humidity sensor are installed in the axle load meter 10. Further, every time the controller 21 receives the measured axle load, the controller 21 also receives a temperature and a humidity at this point in time from the temperature sensor and the humidity sensor. The controller 21 extracts the environment coefficient from the table data illustrated in FIG. 5 on the basis of the received temperature and humidity and calculates the road damage using Equation (1A) for one axle load.

As shown in the table data in FIG. 5, the influence on the road damage increases as the temperature and humidity as the environment coefficient become higher.

The road damage may be calculated every time the axle load is transmitted to the controller 21 or may be calculated by reading the axle load stored in the memory 22 later. Since the road damage is calculated every time the axle load is detected, the road damage is temporarily stored in the RAM 24 inside the controller 21.

The controller 21 accumulates the road damage calculated for each axle load for a predetermined period to calculate period road damage. The calculated period road damage is a damage amount per the predetermined period and stored as the period road damage information 32 in the memory 22. The predetermined period is any period and used for calculating a road life (described later).

Further, the controller 21 accumulates values of the road damage calculated for each axle load to calculate accumulated road damage and causes the memory 22 to store the accumulated road damage as the accumulated road damage information 33. The accumulated road damage is calculated by the controller 21 using the following Equation (2A).

accumulated road damage=Σroad damage=Σ((axle load\hat{ }a)*coefficient) (2A)

Note that an accumulation start point when the accumulation of the road damage is started is a point in time after the road damage calculation system according to the present embodiment is installed and the operation thereof is started. For example, when the operation of the road damage calculation system is started simultaneously with the opening of a road, the road opening time is determined as the accumulation start point. Further, the road damage calculation system may be installed in an existing road. In this case, a point in time when the road damage calculation system is installed and the operation thereof is started may be determined as the accumulation start point. Alternatively, any point in time, such as the beginning of a year or a fiscal year or a point in time when a road repair plan is created, may be determined as the accumulation start point.

In the present embodiment, the load life is calculated (estimated) from the accumulated road damage. The road life is calculated by the controller 21 using the following Equation (3). The controller 21 causes the memory 22 to store the calculated road life as the road life information 35.

road life=(threshold−accumulated road damage)/road damage per predetermined period (3)

In Equation (3), the threshold is the allowable total road damage amount as already described and a value stored as the threshold information 34 in the memory 22. Further, the road damage per the predetermined period is a value stored as the period road damage information 32 in the memory 22, and the accumulated road damage is a value calculated using Equation (2) and stored as the accumulated road damage information 33 in the memory 22.

The threshold information 34 is, for example, information of a damage amount with which a repair is required, that is, the allowable total road damage amount which is determined on the basis of a repair plan which is made on the basis of the construction structure and/or material or the like in the road design stage or an annual repair plan and the like.

The calculated road life shows, for example, after how many days a repair will become required if damage for one day is accumulated as the period road damage. Of course, the period of the accumulation of the period road damage may not be one day, and may be set to any period such as one week, one month, or one year. For example, the road life can be calculated corresponding to the amount of traffic, which changes for each period, according to the period of the accumulation of the period road damage.

Further, a plan of a maintenance or a repair of the road can be made on the basis of the calculated road life, that is, the period after which the repair becomes required. For example, among a plurality of roads, a repair plan of a road having a shorter road life can be preferentially made by obtaining the road life. Further, when the road reaches the end of its road life, that is, the accumulated road damage exceeds the threshold, alarm display or the like may be performed.

The road damage will be further described with numerical examples.

For example, when the road damage calculation system is applied to the expressway network in the urban area illustrated in FIG. 2, the period road damage per day is, for example, 9E*15 in a route A, 8E*15 in a route B, 7E*15 in a route C, and the like.

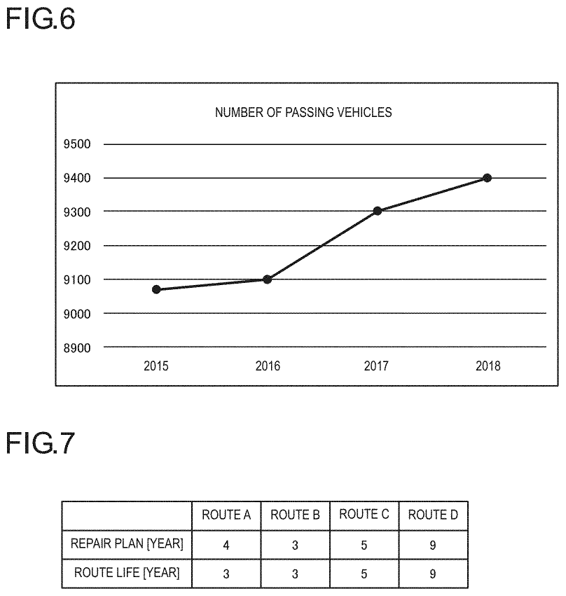

Here, the repair plan will be described. When the repair plan of a road is made, for example, the plan is made on the basis of the number of passing vehicles in each year. FIG. 6 is a graph of the number of passing vehicles in each year in the route A in FIG. 2. It is understood from the graph that the number of passing vehicles increases year by year. The repair plan is formed by estimating the number of passing vehicles in the further from such a graph. For example, it is estimated from the graph of FIG. 6 that the number of passing vehicles in 2020 is approximately 9600 (per day).

In the repair plan, a damage amount accumulated by 2020 is also estimated. Further, it is known, for example, from the documents of the Ministry of Land and the like, Infrastructure, Transport and Tourism described above, that damage applied to a road is the 4th power, the 12th power, or the like of the weight of a vehicle. In this case, the damage amount estimated to be applied by 2020 can be obtained by multiplying a value of the 4th power or the 12th power of the weight of a vehicle that is expected to pass by the estimated number of passing vehicles by 2020. Further, when the damage amount estimated to be applied by 2020 is a repair limit of the road, 2020 is a repair timing.

In the present embodiment, the damage amount which is set in the repair plan formed in this manner can be used as the threshold of Equation (3). That is, in the above example, the road life is calculated using Equation (3) by assigning the damage amount estimated to be applied by 2020 to the threshold.

Accordingly, it is possible to know how many years, months, or days it will take to reach the damage amount estimated to be applied by 2020 from the accumulated road damage actually applied up to now. Accordingly, according to the present embodiment, it is possible to grasp statistical variations in the number of passing vehicles to improve the accuracy of life estimation by annual transitions.

(Road Damage Control)

Next, road damage control for extending the road life after the road life calculation will be described.

FIG. 7 is a diagram illustrating an original repair plan and a road life calculated by the present embodiment.

In FIG. 7, both the repair plan and the road life show after how many years a repair will become required at the point in time when the road life is calculated.

As illustrated in FIG. 7, in the route A, a repair is planned four years later in the original repair plan, but the calculated road life is three more years. In the other routes B, C, D, the repair plan and the road life coincide with each other. This shows that, in the route A, damage applied to the road is larger than damage estimated in the repair plan. Thus, in the route A, a repair is preferably moved up from the original repair plan.

However, the road life of three years of the route A corresponds to the timing of the repair plan of the route B. Thus, there is a possibility that there will be a repair man-hour shortage. Thus, in the present embodiment, the passage of vehicles is controlled so as to extend the road life. Such a method for extending the road life is referred to as road damage control.

The road damage control method, for example, regulates the number of passing vehicles (total number regulation), regulates the passage of a vehicle having a predetermined weight or more (weight regulation), or the like. Such a traffic regulation is output as information about traffic regulation from the server 20, and a road management system, a road administrator, or the like which or who performs traffic regulation receives the information and actually performs the traffic regulation. Hereinbelow, the road damage control method by traffic regulation will be further described with concrete examples.

For example, when the total number regulation is performed, ETC2.0, which is one of road management systems, and a car navigation system mounted on a vehicle can be used.

When the life of the route A is extended, congestion information of the route A is transmitted as information about traffic regulation from the server 20 to the car navigation system using traffic information of ETC2.0. Accordingly, the car navigation system receives information indicating that there is congestion on the route A as traffic information of ETC2.0. The car navigation system that has received the information avoids the route A having congestion and performs navigation to the route B or C that is the other route.

Further, for example, the server 20 transmits congestion information of the route A as information about traffic regulation to a road administrator of a traffic control center or the like. Accordingly, the traffic control center or the like performs traffic regulation on the route A through a display board on the road or the Vehicle Information and Communication System (VICS).

Further, for example, an information provider organization such as a road traffic information center can also be used. In this case, the server 20 transmits congestion information of the route A as information about traffic regulation to the road traffic information center. The road traffic information center or the like receives the congestion information of the route A and provides a driver with the congestion information through a broadcasting medium or a communication medium such as radio, TV, or the Internet. The driver who has listened to (or watched) the congestion information is expected to drive so as to avoid the route A.

Further, the weight regulation is performed, for example, a license plate of a vehicle is identified using a camera, and only a vehicle having a predetermined weight or more identified from the license plate is guided to a route other than the route A. In order to perform such an operation, for example, the server 20 makes a contact with a road administrator of a traffic control center or the like so as to prevent only the vehicle having the predetermined weight or more from passing through the route A as information about traffic regulation. The traffic control center or the like transmits a route for making a detour around the route A to a car navigation system of the vehicle having the predetermined weight or more identified by the license plate. Accordingly, the vehicle having the predetermined weight or more is prevented from passing through the route A.

Further, in the weight regulation, for example, the server 20 transmits an instruction to restrict the passage of the vehicle having the predetermined weight or more on the route A to the traffic control center. The traffic control center restricts the passage of the vehicle having the predetermined weight or more on the route A through a display board on the road or the Vehicle Information and Communication System. Also in such weight regulation, information may be provided to the driver using the road traffic information center.

The vehicle having the predetermined weight or more of which passage is restricted includes, for example, vehicles such as a standard-sized truck having a gross vehicle weight of eight tons or more or a maximum loading capacity of five tons or more and a standard-sized bus having a riding capacity of 30 people or more. Since these vehicles should use a large-sized license plate, these vehicles can be identified from the size of the license plate.

Further, as the traffic regulation, not only congestion information is set for the route A (road), but also, for example, vehicles may be actively guided to a route (road) where the amount of traffic is small among a plurality of routes (roads) other than the route A. For example, the route B and the route C may be compared, and vehicles may be guided to the route C where the amount of traffic is smaller. Specifically, a route to which each vehicle should be guided is transmitted to the car navigation system mounted on the vehicle using ETC2.0 and the car navigation system described above. Further, the vehicles may be guided using the Vehicle Information and Communication System from the traffic control center or may be guided using email or a display board on the road. Of course, also in these cases, not only the total number regulation is performed, but also only the vehicle having the predetermined weight or more may be guided to the route (road) where the amount of traffic is small as the weight regulation.

It is possible to perform control so that the road lives of a plurality of routes (roads) become substantially equal to each other by actively guiding vehicles to a road having a long road life from a road having a short road life due to a large amount of damage accumulation in this manner. For example, it is assumed that, in all of the plurality of routes (roads) A, B, C, the road life is 30 years from the start of use of the road on the basis of the damage amount allowed in the design stage. When 10 years has passed from the start of use of the route A at the present time, and the road life calculated by the present embodiment at the present time is 10 years, the route A reaches the end of its road life after 20 years from the start of use. Assume that the road life of the route B is 30 years and the road life of the route C is 40 years from similar calculation. In such a case, vehicles are guided to the route C by active route guide (only the vehicle having the predetermined weight or more may be guided). Accordingly, the road life of the route A from the start of use can be extended to 30 years. The road life of the route B is originally 30 years. Further, although the road life of the route C also becomes 30 years, the new road life does not exceed the road life in the design stage.

In this manner, in the present embodiment, it is possible to extend the life of a road having a short road life and also make the road lives of a plurality of roads from the start of use substantially equal to each other by performing active route guide as information about traffic regulation. Since the present embodiment makes it possible to make the road lives of a plurality of roads from the start of use substantially equal to each other in this manner, it is possible to reduce long-term and comprehensive man-hours on repairs of a plurality of roads.

Further, as the traffic regulation, vehicles may be guided on the basis of the repair man-hours. For example, traffic regulation is performed on a road requiring much man-hours so as to extend the life of the road requiring much man-hours. More specifically, for example, a repair of a road bridge requires more man-hours than a paved road on the ground. Thus, traffic regulation or the like is performed on the road bridge. On the contrary, when a paved road on the ground is long, and has a road life that requires a repair at the same timing, the repair of the paved road requires more man-hours than the road bridge in some cases. In such a case, traffic regulation is performed on the paved road.

In this manner, in the present embodiment, it is possible to reduce damage applied to the road having a short road life to extend the road life by the road damage control by traffic regulation (including the route guide).

Note that the traffic regulation described herein is, for example, the prohibition of the passage of vehicles (or the vehicle having the predetermined weight or more) on the road to be regulated. Further, the traffic regulation may be the prohibition of the passage of vehicles for a certain period (time) such as prohibiting the passage for a certain time per day. Further, the traffic regulation is not complete passage prohibition, but includes regulation that prevents the passage of vehicles as far as possible like the congestion information.

(Procedure)

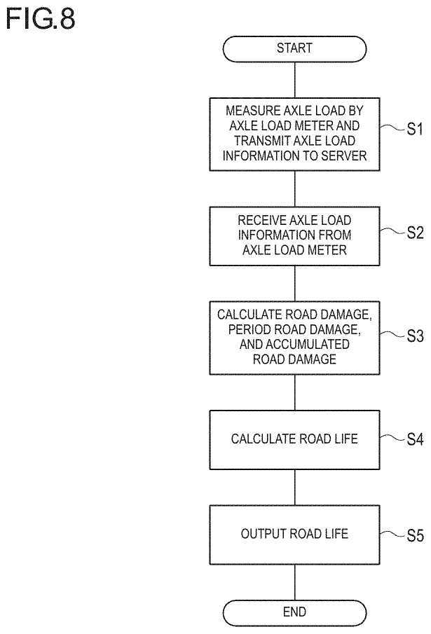

Next, a procedure for the road damage calculation will be described. FIG. 8 is a flowchart illustrating the procedure for the road damage calculation.

First, in the road damage calculation system, a measurement of the axle load by the axle load meter 10 is performed, and the axle load information 31 as a measurement result is transmitted to the server 20 (S1).

Then, the controller 21 of the server 20 receives the axle load information 31 (S2). The received axle load information 31 is temporarily stored in the memory 22.

Then, the controller 21 calculates road damage, period road damage, and accumulated road damage from the axle load information 31 (S3).

Then, the controller 21 calculates a road life from the road damage, the period road damage, and the accumulated road damage (S4).

Then, the controller 21 outputs the road life (S5). The road life output at this time is, for example, a period indicating after how many days, months, or years a road repair will become required from the present time. Further, the controller 21 may output an alarm at the time of outputting the road life when the accumulated road damage exceeds the threshold. An output destination of the road life and the alarm is, for example, a display device installed in the server 20, an external computer, or the like.

After the output of the road life, the controller 21 ends the process. Note that, after the end of the process, the process is started again from S1, the axle loads of all vehicles passing through the road are measured, and the calculation of the road life is sequentially performed.

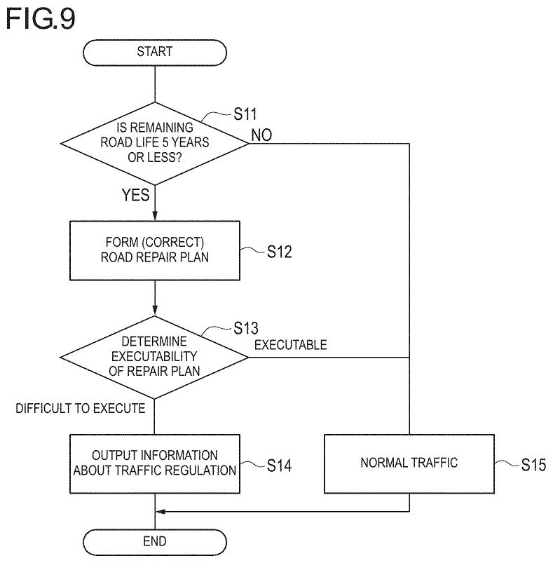

Next, a procedure for the road damage control will be described. FIG. 9 is a flowchart illustrating the procedure for the road damage control.

First, the controller 21 of the server 20 determines whether or not a remaining road life is five years or less on the basis of a result of road life calculation in a plurality of managed road (routes) (S11).

At this time, when there is no road having a road life of five years or less (S11: NO), the controller 21 continues normal traffic (S15).

On the other hand, when there is a road having a road life of five years or less (S11: YES), the controller 21 forms a repair plan or, if there is an existing repair plan, corrects the existing repair plan (S12). The road repair plan is created for a long period of time in many cases. For example, the repair plan is for 10 years later, 30 years later, 50 to 60 years later, or the like. In such a repair plan, the road having a road life of five years or less is a road that requires a repair within a relatively short period. Further, when it is found that the road reaches the end of its life within five years at the point in time when the road life is calculated, a repair plan is preferably formed at this point in time. Thus, in the present embodiment, the repair plan is formed (or corrected) at the point in time when it is found that the road life is five years or less in S11 and S12. Note that the road life is not limited to five years, and, for example, the repair plan may be formed (or corrected) on the basis of the calculated road life regardless of years of the road life.

Then, the controller 21 determines the executability of the formed (or corrected) repair plan (S13). The timing of the repair plan formed (or corrected) in S12 may overlap the timing of a repair plan of another road. Thus, the executability of the repair plan is determined in S13. Here, only the repair plan formed in S12 is determined. This is because a road originally planned to be repaired within five years at this time (that is, not the plan formed in S12) is preferentially repaired. Instead of this, in S13, the road originally planned to be repaired within five years may be determined together with the road of the repair plan formed in S12.

For example, the executability of the repair plan is determined in such a manner that man-hours that can be taken for a road repair, a budget, and the other elements for determining the executability are previously stored in the server 20 for each period, and it is determined whether the repair plan is executable on the basis of the stored elements. When there are a plurality of repair plans, the determination is made for each of the repair plans. Note that the determination may be made by a human. When it is determined that the repair plan is executable (S13: executable), the controller 21 continues normal traffic (S15).

On the other hand, when it is determined that the repair plan is difficult to execute (S13: difficult to execute), the controller 21 outputs information about traffic regulation in order to perform the traffic regulation on the road (S14). As already described, the information about traffic regulation is information for performing the total number regulation, the weight regulation, the route guide or the like on the road where it has been determined that the repair plan is difficult to execute.

(Contactless Axle Load Meter)

Next, the contactless axle load meter of the present embodiment will be described. The principle of the contactless axle load meter is that an image of a tire of a passing vehicle is captured, and an axle load applied to the tire is calculated from a deformation amount of the tire.

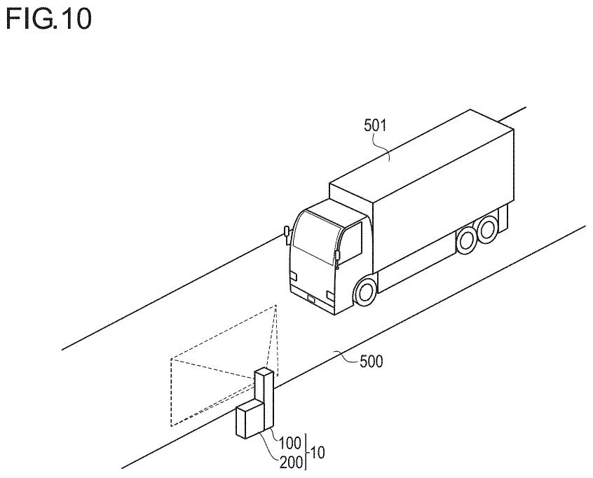

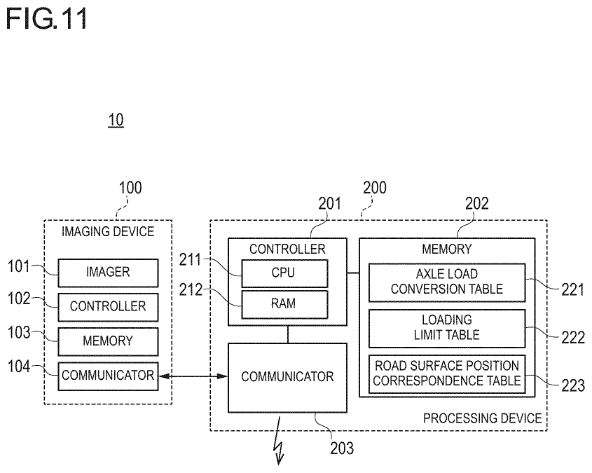

FIG. 10 is a bird's-eye view illustrating an installation state of the contactless axle load meter used in the present embodiment. The contactless axle load meter includes an imaging device 100 and a processing device 200 (refer to FIG. 11).

Examples of the imaging device 100 include a movie camera that captures moving images within a two-dimensional plane and a still camera that captures consecutive still images at predetermined time intervals. Captured images in the imaging device 100 are digital images. The image captured by the imaging device 100 is digital image data, and thus output as it is and transmitted to the processing device 200. Note that when the imaging device (camera) outputs analog data, the analog data is converted to digital image data so that various processes can be performed within the processing device 200 that has received the analog image data.

The imaging device 100 is installed at a position where at least an image of a tire part of a vehicle 501 traveling on a road 500 is captured.

The processing device 200 analyzes the digital image data transmitted from the imaging device 100, calculates a tire deformation amount, and determines whether a loading weight exceeds a specified value (loading limit) on the basis of the calculated tire deformation amount.

FIG. 11 is a block diagram illustrating the functional configuration of the contactless axle load meter.

The imaging device 100 includes an imager 101, a controller 102, a memory 103, a communicator 104, and the like.

The imager 101 includes an optical device that guides visible light input from outside to each pixel position, a detector that detects the quantity of each of RGB color light beams at each pixel position, and the like. Here, in the detector, image sensors are two-dimensionally arrayed on an imaging surface so that a pixel value (e.g., the quantity (luminance value) of each of RGB color light beams) at each pixel position can be acquired, and the detector acquires two-dimensional captured image data.

The controller 102 controls the timing of image capturing by the imager 101, and the light quantity (luminance value) data items obtained by the operation of the imager 101 are output to the memory 103 in a predetermined order. The controller 102 outputs image data temporarily stored in the memory 103 to the processing device 200 through the communicator 104 at an appropriate timing.

The processing device 200 is a computer that performs an arithmetic process, and includes a controller 201, a memory 202, a communicator 203, and the like.

The controller 201 is a processor that controls the operation of the processing device 200 in a centralized manner. The controller 201 includes a CPU (Central Processing Unit) 211 that performs various arithmetic processes, a RAM (Random Access Memory) 212 that provides the CPU 211 with a memory space for operation and stores temporary data, and the like.

The memory 202 stores various programs, setting data, recorded image data, an analysis result thereof, and the like. A nonvolatile memory such as a rewritable flash memory, a HDD (Hard Disk Drive), or the like can be used as the memory 202. Further, the programs, initial setting data, and the like may be stored in a mask ROM and the like.

The programs include an analysis processing program of image data transmitted from the imaging device 100. The CPU 211 of the controller 201 reads the programs and setting data from the memory 202, causes the RAM 212 to store the read programs and setting data, and executes the programs. The setting data includes an axle load conversion table 221, a loading limit table 222, a road surface position correspondence table 223, and the like.

The axle load conversion table 221 is table data for converting parameters relating to the deformation amount (the amount of deformation under load) of a tire calculated by the processing device 200 to an axle load (the correspondence relationship between the deformation amount of the tire and the axle load of the vehicle). The table is not limited to one type, and a plurality of types of tables may be separately held corresponding to the tire size, the tire type, the vehicle type, and the like.

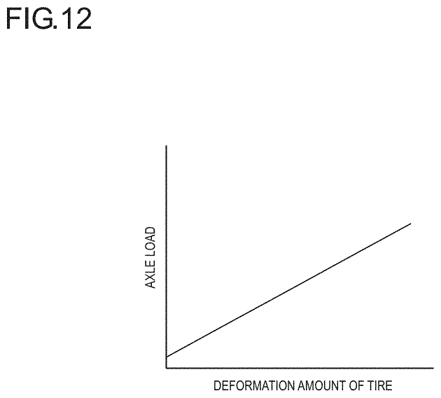

FIG. 12 is a graph illustrating the correspondence relationship between the deformation amount of the tire and the axle load of the vehicle. The horizontal axis represents the deformation amount of the tire, and the vertical axis represents the axle load. Since FIG. 12 is a graph for illustrating the correspondence relationship, a unit and a scale are omitted. As illustrated in FIG. 12, the axle load increases as the deformation amount of the tire increases. Such a relationship may vary according to the tire size, the tire type, the vehicle type, and the like. Thus, a plurality of axle load conversion tables 221 are preferably prepared corresponding to the tire size, the tire type, the vehicle type, and the like. Further, the tire type and the vehicle type cannot be recognized from an image captured by the camera in some cases. For preparation against such a case, the axle load conversion table 221 for each tire size is preferably prepared as the general-purpose axle load conversion table 221.

The loading limit table 222 is a table that stores a loading weight of a vehicle (including a vehicle body weight) for each vehicle type or the like.

The road surface position correspondence table 223 is a table that stores the correspondence between the pixel positions of the captured image captured by the imaging device 100 and the positions on a road surface (that is, two-dimensional plane) captured in the image.

The communicator 203 performs control for communicating with an external device. The communicator 203 is, for example, a network card, and receives image data from the imaging device 100 and outputs a signal corresponding to an analysis result of the image data by the controller 201 to the external device. Thus, the communicator 203 has specifications corresponding to the specifications of the communicator 25 of the server 20. Note that output can also be performed to an external device other than the server 20. Examples of the external device include an alarm device that performs an alarm operation to a driver of an overloaded vehicle, an operation control device for a crossing gate that stops the passage of an overloaded vehicle, a monitoring device used by an observer, and the like.

Next, a tire deformation amount calculation operation by the processing device 200 of the present embodiment will be described.

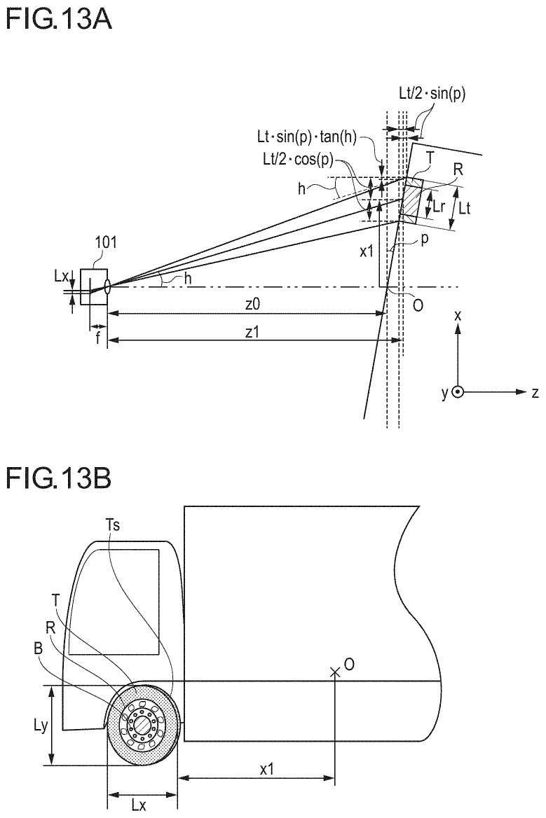

FIG. 13A and FIG. 13B are explanatory diagrams explaining an apparent shape of a tire T of which image is captured. Here, first, a case with no deformation of the tire T will be described.

Since image capturing by the imaging device 100 is discretely performed regardless of whether an image is a still image or a moving image, the tire of a vehicle of which image is to be captured is not always present on the front of the imaging surface. Further, the distance to the tire is not always constant. The relative disposition between the imaging device 100 and the tire T in such a case is illustrated in FIG. 13A. The range direction from the imaging surface is defined as a z direction, the traveling direction of the vehicle within a plane parallel to the imaging surface (horizontal direction) is defined as an x direction, and the vertically upper direction is defined as a y direction.

Here, the side face of the vehicle of which image is to be captured is located at a distance z0 from the imaging surface at a front position O, the distance from the front position O to the tire T in the x direction is a distance x1, and a vehicle body and the tire T having a diameter (outer diameter) Lt are inclined by an angle p (−90<p<90 [deg]) with respect to the imaging surface (within the xz plane). When a side face contour Ts of the tire T is present within a plane at the distance z0, an apparent diameter La (outer diameter) of the tire T in the captured image captured by the imaging device 100 having a focal length f is defined by La=Lt*f/z0. On the other hand, when there is the inclination angle p, the position of the tire T (the distance from a plane parallel to the imaging surface) is shifted by a distance difference (x1*tan (p)±Lt/2*sin (p)) at both ends in the x direction from the front position O. Along with this, an apparent length Lx in the horizontal direction (short-axis direction) passing through the center of the side face contour Ts of the tire T changes from the diameter La (outer diameter). On the imaging surface, the length in the horizontal direction is defined by Lx=Lt*f*z0*cos (p)/((z0+x1*tan (p))2−(Lt/2*sin (p))2) using the focal length f of the lens. When z0+x1*tan (p)=z1, and Lt/2*sin (p) is sufficiently smaller than z1 (that is, the angle p is small), the length Lx is simplified to Lx=f/z1*Lt*(cos (p)−tan (h)*sin (p)). Note that the side face contour Ts described herein does not necessarily have to include asperities such as grooves on the surface of the tire T. Further, the side face itself of the tire T is not a complete flat surface, but may be approximately treated as a flat surface.

On the other hand, a line segment passing through the center of the side face contour Ts of the tire T in the vertical direction is parallel to the imaging surface. Thus, as illustrated in FIG. 13B, an apparent length Ly of the side face contour Ts of the tire T in the vertical direction (long-axis direction) is affected only by the distance z1 from the plane parallel to the imaging surface. That is, the length Ly on the imaging surface is defined by Ly=Lt*f/z1.

The tire T is attached to a rim R of a wheel. The wheel is attached to the vehicle body using a plurality of wheel bolts B (a plurality of bolts that fix the wheel) and wheel nuts that are symmetrically arranged with respect to the center of the side face contour Ts. That is, the wheel bolts B are arranged in a regular polygon. The tire T is compressed and thereby deformed at a tread. On the other hand, there is no deformation in the rim R and the arrangement of the wheel bolts B, and a perfect circle and the regular polygon are thus maintained. The rim R and the wheel bolts B are present within a plane parallel to the side face contour Ts, and the centers thereof are located at the same position (the parallel plane and the same position described herein may include a subtle deviation within an accuracy structurally required). Thus, a deviation of the shape and the pattern from the perfect circle and the regular polygon in a captured image is caused by the positional relationship between the wheel and the imaging surface as described above. Note that although distortion (aberration) caused by the optical device of the imager 101 is regarded as being sufficiently small and thus ignored, correction may be previously performed by a known technology when the distortion cannot be ignored.

As a diameter Lr of the rim R, a length Lrx in the x direction and a length Lry in the y direction of the rim R on the imaging surface are values obtained by replacing the diameter Lt of the tire T in the above lengths Lx, Ly with the diameter Lr of the rim R. Here, the ratio between the length Lrx and the length Lry is obtained from imaging data to cancel out the focal length f and the like. Further, analytical or numerical approximation may be appropriately performed depending on the conditions. For example, when the inclination angle p is sufficiently small as described above, the ratio Rab is analytically defined by Rab=Lrx/Lry=(cos (p)−x1/z1*sin (p)). In an area where such overloading detection is performed, for example, when there is no sharp curve on the road and a lane change is prohibited, the angle p having a too large inclination is not assumed, and approximate handling according to the angle p can be performed.

Further, also when the length of a line segment (diagonal line) connecting two wheel bolts B that are symmetrically arranged with respect to the center (the position of the axle) is equal to the diameter Lr, each value described above can be obtained. In this case, the lengths Lx, Ly may be obtained by performing fitting with an ellipse with respect to the positions of the wheel bolts B in the captured image. Alternatively, the lengths Lx, Ly may be obtained assuming that vertexes are present on both ends in the vertical direction and the horizontal direction using the regular polygon as it is.

The ratio Rab is independent of the diameter Lr. That is, the ratio Rab is a fixed value (constant) for the tire T and the rim R that are concentrically arranged (the centers thereof are located at the same position). Thus, the side face contour Ts of the tire T is converted to a shape viewed within a plane parallel to the imaging surface, that is, a perfect circle having, as a diameter, a converted diameter Lv that is the constant multiple of the diameter La by dividing an x-direction component of the side face contour Ts at each position (each position required for the calculation of the deformation amount) by the ratio Rab or multiplying a y-direction component by the ratio Rab in the captured image of the tire T without identifying each of the specific distances x1, z1 and angle p.

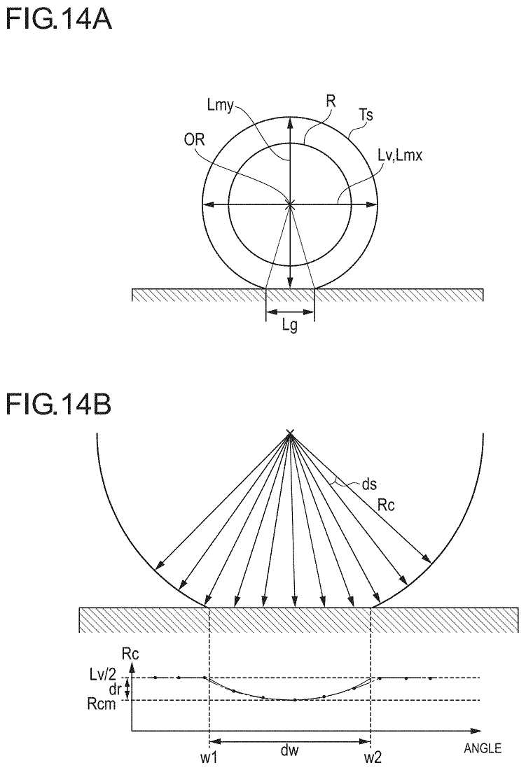

FIG. 14A and FIG. 14B are explanatory diagrams explaining the calculation of the deformation amount of the tire T. In the processing device 200, the deformation amount obtained by converting the tire T (that is, the side face contour Ts) in the captured image to the shape viewed from the front as described above is calculated.

When a load is applied to the tire T, as illustrated in FIG. 14A, a ground contact area is compressed, and the length of a line segment passing through the tread of the tire T and the center of the tire T (the center of a circle including a circular arc part of the side face contour Ts that is not in contact with the ground and thus not deformed) and connecting two points on the side face contour Ts becomes shorter than the original diameter Lt of the tire T. Along with this, among measured converted values Lm each converted from the apparent length of the line segment passing through the center of the tire T and connecting two points on the side face contour Ts in the captured image, a measured converted value Lmy corresponding to a line segment extending in the vertical direction (short-axis direction) is shorter than the above converted diameter Lv (equal to a measured converted value Lmx corresponding to a line segment extending in the horizontal direction (long-axis direction). Further, as illustrated in FIG. 14B, the tread of the tire T linearly extends over a ground contact length Lg (actually extends in a planar manner including the depth direction with respect to the sheet of the drawing). As the load increases, the measured converted value Lmy decreases, and the ground contact length Lg increases. That is, the measured converted value Lmy, the ground contact length Lg, or values corresponding to these values, such as a distance Rc from the center to the side face contour Ts, a contraction amount dLm=Lmx−Lmy (that is, the difference between the maximum value and the minimum value of the length of the line segment), a ground contact angle dw (angle range) that is the central angle formed by the ground contact length Lg, and the like are obtained as parameters (predetermined values) corresponding to the deformation amount. Further, a deformation rate of the tire T may be obtained on the basis of a plurality of measured converted values Lm (the lengths of the line segments in the captured image), such as Lmy/Lmx, dLm/Lmx, and Lg/Lmx (the ratio between the diameter and the ground contact length) that are the ratios between the above values and the converted diameter Lv=Lmx.

A minimum distance Rcm that is a minimum value of the distance Rc is a part of the measured converted value Lmy on a line extending in the vertical direction when the road surface is horizontal. When the vertical direction in the captured image captured by the imager 101 can be identified, the length Rc in the vertical direction can be directly obtained. The vertical direction can be identified, for example, in a case where the image capturing range of the imager 101 is fixed in the vertical direction and the horizontal direction and a case where a marker indicating the vertical direction is present within an image of a subject.

The distance Rc is obtained by obtaining a center position OR of the side face contour Ts of the tire T and then obtaining the distance from the center position OR to the side face contour Ts. Since the center position OR of the tire T (the center of the circle including the undeformed circular arc part on the captured image) matches the center position of the rim R, the center of the rim R, which is obtained when the rim R in the captured image is converted to a perfect circle, can be determined to be the center of the tire T as it is. Alternatively, separately from the rim R, the intersection point between a line segment having the maximum vertical-direction length of the side face contour Ts of the tire T and a line segment having the maximum horizontal-direction length may be obtained and determined to be the center of the tire T

When the identification of the distance x1 is not required, the distance Rc may be obtained without identifying the center position OR. That is, the distance Rc can be obtained by Rc=Lm−(Lmx/2). The minimum distance is defined by Rcm=Lmy−(Lmx/2).

Further, the minimum distance Rcm may be numerically calculated instead of precisely determining the vertical direction in the captured image and obtaining the minimum distance Rcm along the vertical direction. For example, a plurality of distances Rc from the center of the tire T to the side face contour Ts are acquired in order at predetermined angle intervals ds. Then, the minimum distance Rcm can be obtained by fitting (the distribution of the distances from the center to points on a chord formed by the tread) or interpolation for a part where the distance Rc is smaller than (different from) the converted length (Lv/2)=(Lmx/2) corresponding to the original tire radius (Lt/2), which is the maximum value. Similarly, the ground contact angle dw=w2−w1 is obtained from the difference between angles w1, w2 at both ends of the chord obtained by the fitting.

In the processing device 200, in the calculation of the tire deformation amount, the side face contour Ts of the tire T detected from data of the captured image should be converted to the shape viewed from the front only at the position, length, or angle range required for obtaining a parameter required for identifying the above deformation amount. That is, the entire side face contour Ts does not necessarily have to be converted to the shape viewed from the front.

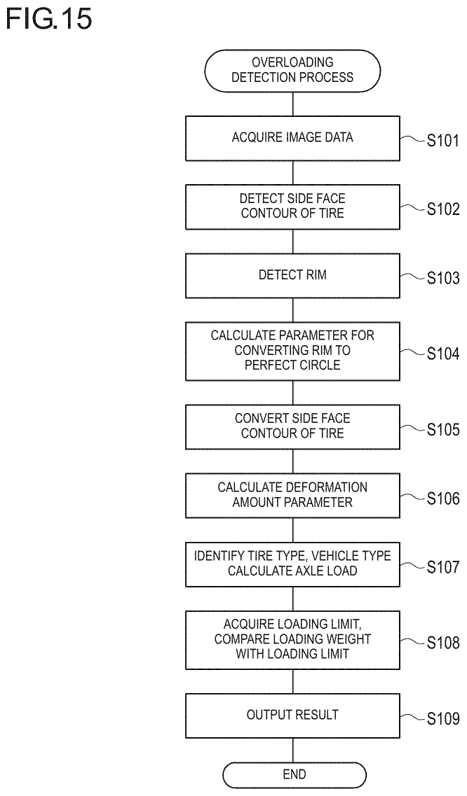

FIG. 15 is a flowchart illustrating a procedure of axle load calculation and overloading detection that are executed in the processing device of the contactless axle load meter. The process is performed by the controller 201 by executing a program based on the procedure. Further, the procedure is started every time one piece of image data is input from the imaging device 100.

After the start of an overloading detection process, the controller 201 (CPU 211) acquires captured image data to be analyzed (S101). The controller 201 detects a tire (a side face contour of the tire) of a wheel included in a vehicle from the captured image (S102; detection step). The detection of the tire is performed on the basis of, but not particularly limited to, detection of a shape pattern of the vehicle and the like. The detection may be performed on the basis of a part where a movement is detected (a difference is generated) in a plurality of consecutive images.

The controller 201 detects an object having a circular shape (a circular or regular polygonal shape or pattern), which may include a distortion within an error range, from the inside of the detected tire (S103; identification step). The object to be detected is previously identified to have a circular shape, and the controller 201 detects (identifies) the rim of the wheel. The detection of the rim is performed, for example, by detecting (identifying) a circular object having its center near the center of the detected tire (the center is not precisely determined at this point) and the boundary between the tire and a part having a color different from the color of the tire. The circular shape (or the regular polygonal shape) may include not only a perfect circle or a perfect regular polygon, but also a circle or a regular polygon a part of which lacks.

The controller 201 calculates a parameter for correcting the shape of the rim to a perfect circle (S104; converted value acquisition step). As described above, the controller 201 obtains a parameter for returning the apparent shape, which is deviated from a perfect circle, to a perfect circle. The controller 201 converts the shape of the side face contour Ts of the tire T on the basis of the obtained parameter (S105).

The controller 201 calculates any of the above parameters indicating the deformation amount on the basis of the converted shape of the side face contour Ts of the tire T (S106).

The controller 201 identifies the types of the tire and the vehicle on the basis of the obtained tire size and the like and calculates the axle load from the parameter of the deformation amount (S107). The controller 201 may identify the types of the tire and the vehicle directly from indicators, such as characters and symbols put on the tire and the vehicle, or identify the shapes of the tire and the vehicle by pattern matching.

The controller 201 acquires the loading limit corresponding to the tire type and the vehicle type with reference to the loading limit table 222. The controller 201 compares the obtained loading weight and the loading limit to determine whether the loading weight exceeds the loading limit (determination of overloading) (S108).

The controller 201 outputs the result relating to the obtained axle load and loading weight (S109). The output axle load is transmitted to the server 20. Then, the controller 201 ends the overloading detection process.

In the above process, the distance (subject distance) from the imager 101 to the tire (subject), that is, the absolute value of the size of the tire T is not taken into consideration. However, the size of the tire T is required in some cases in order to acquire the tire type, strength information corresponding to the tire type, and the like. As illustrated in FIG. 13A and FIG. 13B, the size (lengths Lx, Ly) of the tire T in the captured image depends on the distance z1 (to be precise, the length Lx also depends on the distance x1).

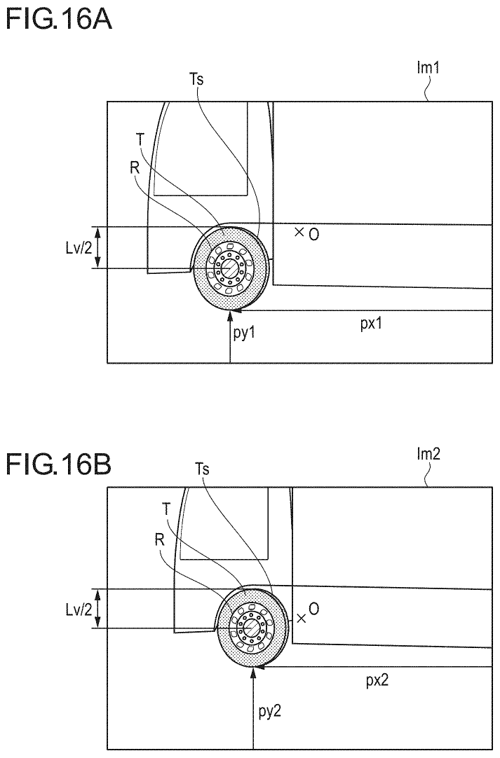

FIG. 16A and FIG. 16B are explanatory diagrams explaining the identification of the distance between the imaging surface and the tire T of which image is to be captured. When the imager 101 and the angle of view thereof (focal length) are fixed, the position on a ground surface corresponding to each pixel position of the captured image is determined. Thus, the distances z1, x1 can be obtained from the distance between a reference point (predetermined reference position) in the captured image, such as four corners, and the ground contact point of the tire T (the intermediate point of the line segment having the ground contact length Lg). Here, for example, as illustrated in FIG. 16A, the length from the bottom right corner in a captured image Im1 to the center of the ground contact length Lg of the tire T is a length px1 to the left and a length py1 to the top.

The position (x, z) on the road surface, which is a predetermined y value, and this (px1, py1) are associated with each other and stored as the road surface position correspondence table 223 in the memory 202. Further, when the lengths px1, py1 are identified, the position (x, z)=(x1, z1) at the center of the ground contact length Lg of the tire T is identified by referring to the road surface position correspondence table 223. The focal length f is known, and the actual diameter Lt=La*z1/f of the tire T is obtained by obtaining the diameter La of the tire T in the captured image Im1.

In FIG. 16B, a length py2 is larger than the length py1, and a length px2 is smaller than the length px1 in a captured image Im2. In this case, the vehicle passes through a place more distant from the imaging surface than that in the case of FIG. 16A, and Lv/2, which is the tire radius in the captured image, is smaller than that in the case of FIG. 16A. In order to obtain the diameter Lt of the tire T in such a case, the distances z1, x1 are first identified on the basis of the lengths px1, px2, py1, py2.

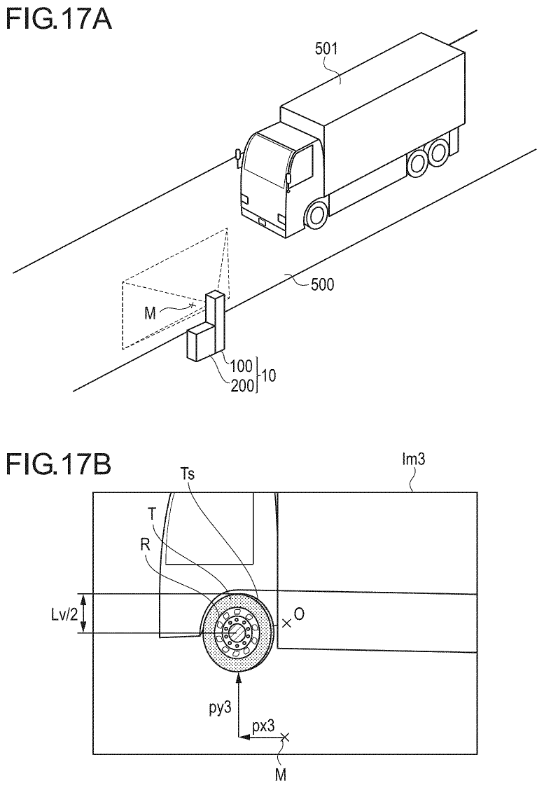

FIG. 17A and FIG. 17B are explanatory diagrams explaining another method relating to the identification of the distance between the imaging surface and the tire T of which image is to be captured. As illustrated in FIG. 17A, a marker M is disposed on a road surface. As illustrated in FIG. 17B, a captured image Im3 includes both the marker M and the tire T. The position (x, z) of the marker M with respect to the imager 101 is previously stored in the memory 202. Further, the correspondence relationship between the relative position (px3, py3) between the marker M and the tire T in the captured image Im3 and the position (x, z) on the road surface is stored in the road surface position correspondence table 223. Accordingly, the distances x1, z1 are obtained by obtaining the relative position (px3, py3).

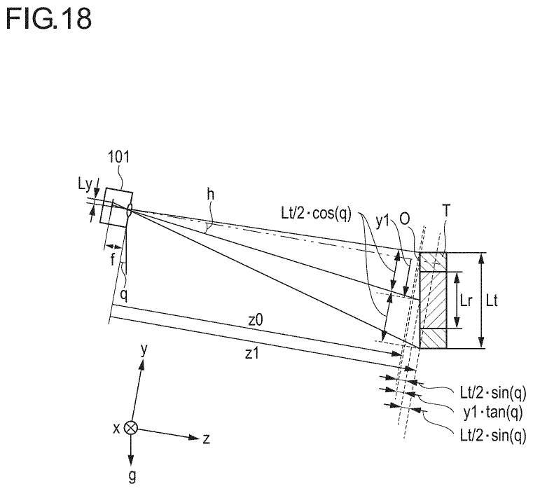

FIG. 18 is a diagram illustrating a modification of the contactless axle load meter. In FIG. 18, the downward direction corresponds to the vertical direction (g direction).

Here, the imager 101 captures an image obliquely downward at a position slightly higher than the road surface and the center of the tire T. In such a case, the tire is inclined by an angle q (the angle between the side face contour Ts and the imaging surface) with respect to the imaging surface within the yz plane. Accordingly, the apparent length Ly in the y direction in the captured image is deviated from the converted diameter Lv. Such an inclination can also be converted to that in the case where the tire T is viewed from the front from the captured image in a manner similar to the inclination within the xz plane described above.

Further, when the inclination within the xz plane and the inclination within the yz plane are present at the same time, a similar conversion can be performed on both the inclinations. In this case, the deformation amount may be calculated after the entire side face contour Ts is converted, or many line segments each passing through the center and connecting two points on the side face contour Ts may be acquired from the captured image, and the deformation amount may be acquired on the basis of maximum and minimum values after conversion, the distribution of lengths, and the like.

In this manner, the controller 201 of the processing device 200 in the contactless axle load meter detects the side face contour Ts of the tire T of the wheel included in the vehicle from the captured image captured by the imaging device 100. The controller 201 calculates the deformation amount of the side face contour Ts corresponding to the weight of the vehicle. The controller 201 identifies a circular or regular polygonal shape or pattern within a plane parallel to the side face contour Ts. The controller 201 obtains a converted value for converting the shape in the captured image of the identified shape or pattern to a perfect circle or a regular polygon. Then, the controller 201 converts a predetermined value (parameter) relating to the deformation amount of the tire T in the captured image using the obtained converted value to calculate the deformation amount on the basis of the converted predetermined value. In this manner, even under the condition where the tire T is inclined with respect to the imaging surface, the processing device 200 appropriately performs coordinate transformation to convert the side face contour Ts of the tire T to the shape viewed from the front and calculates the tire deformation amount using the converted side face contour Ts. Accordingly, in the contactless axle load meter, even when an image of the tire T is not captured at the instant when the tire T comes to the front, a precise deformation amount can be obtained by capturing images of the tire T at appropriate intervals during traveling of the vehicle. Thus, in the contactless axle load meter, it is not necessary to set the image capturing intervals extremely short relative to the traveling speed of the vehicle. Further, the contactless axle load meter is capable of obtaining a precise deformation amount even when the vehicle is traveling in a direction not parallel to the imaging surface. Thus, it is possible to measure the axle load from the deformation amount of the tire and prevent vehicles from escaping from the measurement of overloading and the like. Thus, in the processing device 200, it is possible to more practically detect the deformation of a tire of a vehicle caused by overloading and the axle load along therewith.

Further, the controller 201 identifies a circular or regular polygonal shape or pattern inside the side face contour Ts in the captured image. That is, since the controller 201 detects a circular object in the wheel, the side face contour Ts of the tire T can be appropriately converted to the shape viewed from the front even when the wheel and the vehicle body face in different directions.

Further, the controller 201 identifies the above shape or pattern having its center at the same position as the center of the tire T. Accordingly, it is possible to more precisely acquire the converted value of an apparent deviation of the tire T at the same position as the tire T. Further, is it possible to separately and easily identify the center position of the deformed tire T.

Further, the controller 201 identifies the rim R of the wheel as the above shape or pattern. Since the rim R is concentric with the tire T, and the radius of the rim R is not largely different from the radius of the tire T, the converted value can be accurately obtained.

Further, the controller 201 identifies the wheel bolts B that fix the wheel as the above shape or pattern. Since the wheel bolts B are concentric with the tire T and arranged in a regular polygon, the converted value can be accurately obtained in a manner similar to the rim R.

Further, the controller 201 identifies a shape or pattern having a color different from the color of the side face contour Ts of the tire T. Thus, it is possible to easily and precisely extract the shape or pattern from the captured image. Accordingly, an accurate converted value can be obtained.

Further, the controller 201 acquires, as the converted value, the ratio between the length in the long-axis direction and the length in the short-axis direction of the above shape or pattern and calculates the parameter relating to the deformation amount using the ratio. It is possible to appropriately obtain the parameter relating to the deformation amount of the side face contour Ts with a simple arithmetic operation and without largely reducing the accuracy by simply obtaining the converted value as the ratio between the lengths of the two axes of an ellipse in this manner.

Further, the controller 201 obtains a converted value corresponding to the angles p, q between the side face contour Ts and the imaging surface of the captured image. That is, in addition to the case where the vehicle is traveling obliquely to the imaging surface, the imager 101 itself can also be titled. Accordingly, it is possible to avoid dirt on the imaging surface (a light incidence surface to the imaging surface) caused by splashes of mud by traveling of the vehicle or the like by capturing an image from a position slightly higher than the ground. Further, it is possible to reduce dirt on the imaging surface caused by adhesion of rain drops or the like by setting the image capturing direction to the slightly downward direction.

Further, the controller 201 obtains a converted value on the basis of the subject distance z1 between the imaging surface and the side face contour Ts in the captured image. That is, the converted value can be more precisely obtained. Further, it is possible to easily determine the size and type of the tire and the like and thereby more appropriately determine overloading by enabling precise identification of the absolute value of the actual converted diameter Lv on the basis of not only the ratio between the deformation amount of the ground contact length Lg, the contraction amount dLm, or the like and the converted diameter Lv and the like, but also the subject distance z1.

Further, the controller 201 obtains the subject distance z1 on the basis of the distance between the predetermined reference position (bottom right corner) in the captured image (e.g., the captured image Im1) and the side face contour Ts (here, the center position of the ground contact length Lg). Since the position (x, z) on the road surface that remains relatively stationary can be associated with the pixel position by fixing the angle of view of the camera, it is possible to easily identify the position in contact with the ground surface in the side face contour Ts. Accordingly, the subject distance z1 is easily identified, and the converted value of the parameter relating to the deformation amount can be appropriately acquired.

Further, the controller 201 calculates the deformation amount using the length Ly in the vertical direction and the length Lx in the horizontal direction of the side face contour Ts converted to values in the shape viewed from the front. Accordingly, it is possible to efficiently and appropriately obtain the deformation amount of the tire T deviated from the center of the angle of view of the imaging device 100 in the traveling direction of the vehicle.

Further, the controller 201 acquires the lengths of a plurality of line segments each passing through the center of the circle including the undeformed circular arc part of the converted side face contour Ts and connecting two points on the side face contour Ts, and calculates the deformation amount on the basis of the acquired lengths of the line segments. The lengths of a plurality of line segments are acquired not only in the horizontal direction and the vertical direction, but also in other directions as described above to numerically acquire the distribution of deformation of the side face contour Ts of the tire T. Accordingly, the deformation amount can be flexibly and precisely obtained on the basis of the distribution of deformation.

Further, the controller 201 calculates the deformation amount on the basis of the difference between the maximum value and the minimum value of the acquired lengths of the line segments. The deformation amount can be estimated with a simple and easy process and used in the determination of overloading by such a simple calculation of the deformation amount.

Further, the controller 201 calculates the deformation amount using the ground contact length Lg of the converted side face contour Ts in contact with the ground surface. It is also easy to directly detect such a deformed part, and the deformation amount can be appropriately estimated and used in the determination of overloading.

Further, the controller 201 obtains the ground contact length Lg or a value corresponding to the ground contact length Lg by obtaining the ground contact angle dw that is the angle range in which the distance Rc between the center of the circle including the undeformed circular arc part of the converted side face contour Ts and a point on the side face contour Ts differs from the maximum value thereof (Lv/2). Since the tire T has a three-dimensional structure and also has grooves and the like, the side face contour Ts is not clearly determined from the captured image in some cases. In such a case, the value corresponding to the ground contact length Lg can be easily and appropriately acquired without arbitrariness or the like of determination and used in the determination of overloading by not directly determining the presence or absence of contact of each point with the ground, but identifying the most likely ground contact range from a plurality of data points.

Further, the controller 201 calculates the deformation amount on the basis of the ratio between the converted diameter Lv corresponding to the diameter of the circle including the undeformed circular arc part of the converted side face contour Ts and the ground contact length Lg. In this manner, the ratio between the ground contact length Lg, which is a parameter directly relating to overloading, and the converted diameter Lv is obtained to define a parameter that more appropriately reflects whether the load is within an appropriate range relative to the diameter of the tire T. Accordingly, the parameter can be appropriately used in the determination of overloading regardless of the diameter of the tire T.

The contactless axle load meter configured in the above manner is capable of more flexibly responding to the traveling state of the vehicle and obtaining the axle load of the vehicle from the deformation amount of the tire T as described above.

The present embodiment described above achieves effects as described below.

The present embodiment installs the axle load meter 10 in a road to be managed, measures the axle load of a passing vehicle, calculates road damage from the obtained axle load, and accumulates the road damage to calculate accumulated road damage. Accordingly, it is possible to accurately deal with variable damage caused by the passage of vehicles on the road and precisely grasp a load applied to the road. Further, it is possible to estimate the degree of deterioration based on the use condition of the road.

In particular, the present embodiment uses the contactless axle load meter. Since the contactless axle load meter is low in cost and easy to install, the axle load can be acquired in many roads in any places. Thus, in any road where the camera of the contactless axle load meter can be installed, damage applied to the road can be grasped.

Further, in the present embodiment, the road life is calculated from the road damage and the accumulated road damage. Thus, it is possible to make a repair plan or correct a repair plan before the road reaches the end of its road life, which is the expiration date of the road, not only grasping the damage applied to the road up to now.

Further, the present embodiment is capable of controlling damage applied to the road in the future by performing traffic regulation as necessary on the basis of a repair plan formed on the basis of the road life.

Although the present embodiment to which the present invention is applied has been described above, the present invention is not limited to the above embodiment and can be variously modified.

For example, in the present embodiment, the contactless axle load meter is used as the load detector. Alternatively, the present invention may use the axle load meter 10 that directly measures the axle load.

Further, the present invention may measure a wheel load, which is a vertical load applied to a road by a wheel, as the load detected by a load detector instead of the axle load meter 10. The wheel load is measured using a wheel load meter. In this case, as described below, the road damage is calculated using Equation (1B), and the accumulated road damage is calculated using Equation (2B). Note that, in these equations, the constant a and the coefficient are as already described.

road damage=(wheel load\hat{ }a)*coefficient (1B)

accumulated road damage=Σroad damage=Σ((wheel load\hat{ }a)*coefficient) (2B)

Further, the present invention may measure the load of a load carried in the vehicle as the load detected by a load detector instead of the axle load meter 10. The carrying load is measured using a carrying load meter. In this case, as described below, the road damage is calculated using Equation (1C), and the accumulated road damage is calculated using Equation (2C). Note that, in these equations, the constant a and the coefficient are as already described.

road damage=(carrying load\hat{ }a)*coefficient (1C)

accumulated road damage=Σroad damage=Σ((carrying load\hat{ }a)*coefficient) (2C)

Further, the total load (total weight) of the vehicle including the carrying load may be used. In this case, the road damage and the accumulated road damage may be calculated using Equation (1) and Equation (2) already described above.

In this manner, the present invention can use various measuring instruments to be the load detector instead of the axle load meter 10, and calculate the accumulated road damage and grasp a load applied to the road from the obtained accumulated road damage as already described by using these measuring instruments. Further, the road life can be obtained using Equation (3) described above. Further, it is also possible to form or correct a repair plan on the basis of the road life and further perform traffic regulation and the like as necessary.

Further, the present invention can calculate not only damage of a road where the load detector is installed, but also damage of a road where the load detector is not installed. In ETC2.0, traveling history data of a passing vehicle can be acquired from the vehicle. Thus, when the axle load meter 10 is installed in an ETC lane, it is possible to track a vehicle passing through the ETC lane. Thus, also in a road other than an ETC lane, that is, a road where the axle load meter 10 is not installed, when a vehicle of which axle load has been measured once passes through the road, a load applied by the vehicle can be obtained. Of course, not only the load detector that detects the axle load, but also the load detector that detects another load of the vehicle (the wheel load, the carrying load, and the like) may be installed in a lane of ETC2.0.

In the track of the vehicle of which load has been detected, for example, a camera is installed in the ETC lane, and the characteristics of the vehicle of which load has been detected is stored (the camera of the contactless axle load meter may be used as the camera, or an additional camera may be provided). The characteristics of the vehicle include, for example, a number of a license plate, the characteristics of the entire vehicle or a part of the vehicle within an image, or the like. Further, in a road where the load detector is not installed, for example, the vehicle is tracked by recognizing the vehicle by an automatic vehicle license-number detection device or recognizing the characteristics of the vehicle from an image of a surveillance camera or the like. Accordingly, in the present invention, also in a road where the load detector is not installed, it is possible to obtain road damage and calculate the accumulated road damage. The surveillance camera may be an existing camera, or an additional camera may be installed.

Further, although the embodiment describes one server 20 that calculates the road damage as an example, the present invention is not limited thereto and may calculate the road damage using a cloud server or the like. When the cloud server is used, the storage of information such as the axle load information 31, the period road damage information 32, the accumulated road damage information 33, the threshold information 34, and the road life information 35, the calculation of the road damage, the accumulated road damage, and the road life, the formulation (or correction) of a repair plan, and the like may be performed by different servers. Further, only the storage of information may be performed by the cloud server, and the calculation of the road damage, the accumulated road damage, and the road life, the formulation (or correction) of a repair plan, and the like may be performed by a computer communicable with the cloud server.

Further, the road damage control may be performed not only in a case where a repair plan is difficult to execute, but also after the calculation of the road life as necessary.

Further, the present invention can be variously changed also in the contactless axle load meter used in the embodiment.

For example, as the parameter relating to the deformation amount of the tire, area and the like may be used in addition to length and angle. The deformation amount can be relatively easily obtained by obtaining the area on the basis of the number of pixels and converting the number of pixels and the unit area per pixel to values in front view.

Further, in the present embodiment, the angle of the side face contour Ts with respect to the imaging surface or the like is acquired using the rim R or the like located inside the side face contour Ts of the tire T. However, any structure outside the side face contour Ts that indicates the angel of the side face contour Ts, that is, the structure that moves in conjunction with the orientation of the axle or the like may be used. Further, any undeformable pattern disposed on the tire T itself may be used.

Further, although, in the embodiment, the structure originally included in the wheel, such as the rim R or the wheel bolts B of the wheel, is identified to calculate the converted value, the present invention is not limited thereto. A circular pattern may be additionally formed on the tire T. Further, the pattern may not have a center on the axle.

Further, although the embodiment describes that the color of the rim R and the wheel bolts B differs from the color of the tire T, a detection algorithm may be configured so that the rim R and the wheel bolts B are detectable even when the rim R and the wheel bolts B have the same color as the tire T.

Further, although the embodiment describes the case where an image is captured horizontally or obliquely downwardly in the direction orthogonal to the extending direction of the road, the present invention is not limited thereto. For example, the imaging device 100 may capture an image facing in the oblique direction with respect to the approaching direction of the vehicle.

Further, although, in the embodiment, the subject distance (the distance to the side face contour Ts) is calculated from the captured image, the subject distance may be acquired using an additional sensor or the like.

Further, although the embodiment describes the contactless axle load meter in which the imaging device 100 and the processing device 200 are integrated together, a tire deformation amount calculation device that detects overloading on the basis of an image acquired from the imaging device 100 that is separately provided may be independently provided.

Further, although the above embodiment describes that the deformation amount and the loading weight are held as tables according to the tire types and the vehicle types, the common table data may be weighted on the basis of data on the load ratio of tires to convert the deformation amount to the loading weight in a case where tires of the same type are provided in different numbers or the like.

In addition, specific details such as the specific configurations, process details, and procedures described in the above embodiment can be appropriately modified without departing from the gist of the present invention.

Although embodiments of the present invention have been described and illustrated in detail, the disclosed embodiments are made for purpose of illustration and example only and not limitation. The scope of the present invention should be interpreted by terms of the appended claims.

What is claimed is:

1. A road damage calculation system comprising:
a load detector that detects a load applied to a road from a vehicle on the road; and
a hardware processor that calculates road damage from the load obtained by the load detector, and accumulates the calculated road damage to calculate accumulated road damage.

2. The road damage calculation system according to claim 1, wherein
the hardware processor calculates the road damage from the load acquired from the load detector using the following Equation (1) and calculates the accumulated road damage using the following Equation (2),
road damage=(load\hat{ }a)*coefficient (1)
accumulated road damage=Σroad damage=Σ((load\hat{ }a)*coefficient) (2)
(in Equations (1) and (2), a constant a is a value for calculating damage applied to the road by the load, and a coefficient is a value affecting the road damage and at least one of an environment coefficient based on temperature and/or humidity, an age coefficient based on aging of the road, a structure coefficient based on a construction structure of the road, and a material coefficient based on a material of the road).

3. The road damage calculation system according to claim 1, wherein
the load detector is an axle load meter, and
the hardware processor calculates the road damage from an axle load acquired from the axle load meter using the following Equation (1A) and calculates the accumulated road damage using the following Equation (2A),
road damage=(axle load\hat{ }a)*coefficient (1A)
accumulated road damage=Σroad damage=Σ((axle load\hat{ }a)*coefficient) (2A)
(in Equations (1A) and (2A), a constant a is a value for calculating damage applied to the road by the axle load, and a coefficient is a value affecting the road damage and at least one of an environment coefficient based on temperature and/or humidity, an age coefficient based on aging of the road, a structure coefficient based on a construction structure of the road, and a material coefficient based on a material of the road).

4. The road damage calculation system according to claim 3, wherein
the axle load meter is a contactless axle load meter including:
an imaging device that captures an image of a tire of a wheel included in a vehicle; and
a processor that obtains the axle load from a deformation amount of the tire.

5. The road damage calculation system according to claim 1, wherein
the load detector is a wheel load meter, and
the hardware processor calculates the road damage from a wheel load acquired from the wheel load meter using the following Equation (1B) and calculates the accumulated road damage using the following Equation (2B),
road damage=(wheel load\hat{ }a)*coefficient (1B)
accumulated road damage=Σroad damage=Σ((wheel load\hat{ }a)*coefficient) (2B)
(in Equations (1B) and (2B), a constant a is a value for calculating damage applied to the road by the wheel load, and a coefficient is a value affecting the road damage and at least one of an environment coefficient based on temperature and/or humidity, an age coefficient based on aging of the road, a structure coefficient based on a construction structure of the road, and a material coefficient based on a material of the road).

6. The road damage calculation system according to claim 1, wherein
the load detector is a carrying load meter, and
the hardware processor calculates the road damage from a carrying load acquired from the carrying load meter using the following Equation (1C) and calculates the accumulated road damage using the following Equation (2C),
road damage=(carrying load\hat{ }a)*coefficient (1C)
accumulated road damage=Σroad damage=Σ((carrying load\hat{ }a)*coefficient) (2C)
(in Equations (1C) and (2C), a constant a is a value for calculating damage applied to the road by the carrying load, and a coefficient is a value affecting the road damage and at least one of an environment coefficient based on temperature and/or humidity, an age coefficient based on aging of the road, a structure coefficient based on a construction structure of the road, and a material coefficient based on a material of the road).

7. The road damage calculation system according to claim 1, wherein
the load detector is installed at a position where the load detector is capable of detecting the load of a vehicle passing through an ETC lane where ETC2.0 is installed, and
the hardware processor tracks a vehicle of which the load has been detected on the basis of traveling history data by ETC2.0 to calculate the road damage and the accumulated road damage of the road other than the ETC lane.

8. The road damage calculation system according to claim 1, wherein
the hardware processor further estimates a road life using the following Equation (3),
road life=(allowable total road damage amount−accumulated road damage)/road damage per predetermined period (3).

9. The road damage calculation system according to claim 8, wherein
the allowable total road damage amount is a value determined on the basis of a construction structure and/or a material of the road.

10. The road damage calculation system according to claim 8, wherein
the hardware processor outputs an alarm when the accumulated road damage exceeds the allowable total road damage amount.

11. The road damage calculation system according to claim 8, wherein
the hardware processor forms a repair plan of the road or corrects an existing repair plan on the basis of the road life.

12. A road damage calculation method comprising:
(a) detecting a load applied to a road from a vehicle on the road;
(b) calculating road damage from the detected load; and
(c) accumulating the calculated road damage to calculate accumulated road damage.

13. The road damage calculation method according to claim 12, wherein
the (b) calculates the road damage from the load detected in the (a) using the following Equation (1), and the (c) calculates the accumulated road damage using the following Equation (2),
road damage=(load\hat{ }a)*coefficient (1)
accumulated road damage=Σroad damage=Σ((load\hat{ }a)*coefficient) (2)
(in Equations (1) and (2), a constant a is a value for calculating damage applied to the road by the load, and a coefficient is a value affecting the road damage and at least one of an environment coefficient based on temperature and/or humidity, an age coefficient based on aging of the road, a structure coefficient based on a construction structure of the road, and a material coefficient based on a material of the road).

14. The road damage calculation method according to claim 12, wherein
the load in the (a) is an axle load of a vehicle measured by an axle load meter, and
the (b) calculates the road damage from the axle load acquired from the axle load meter using the following Equation (1A), and the (c) calculates the accumulated road damage using the following Equation (2A),
road damage=(axle load\hat{ }a)*coefficient (1A)
accumulated road damage=Σroad damage=Σ((axle load\hat{ }a)*coefficient) (2A)
(in Equations (1A) and (2A), a constant a is a value for calculating damage applied to the road by the axle load, and a coefficient is a value affecting the road damage and at least one of an environment coefficient based on temperature and/or humidity, an age coefficient based on aging of the road, a structure coefficient based on a construction structure of the road, and a material coefficient based on a material of the road).

15. The road damage calculation method according to claim 14, wherein
the axle load is measured by a contactless axle load meter including:
an imaging device that captures an image of a tire of a wheel included in a vehicle; and
a processor that obtains the axle load from a deformation amount of the tire.

16. The road damage calculation method according to claim 12, wherein
the load in the (a) is a wheel load of a vehicle measured by a wheel load meter, and
the (b) calculates the road damage from the wheel load acquired from the wheel load meter using the following Equation (1B), and the (c) calculates the accumulated road damage using the following Equation (2B),
road damage=(wheel load\hat{ }a)*coefficient (1B)
accumulated road damage=Σroad damage=Σ((wheel load\hat{ }a)*coefficient) (2B)
(in Equations (1B) and (2B), a constant a is a value for calculating damage applied to the road by the wheel load, and a coefficient is a value affecting the road damage and at least one of an environment coefficient based on temperature and/or humidity, an age coefficient based on aging of the road, a structure coefficient based on a construction structure of the road, and a material coefficient based on a material of the road).

17. The road damage calculation method according to claim 12, wherein
the load in the (a) is a carrying load of a vehicle measured by a carrying load meter, and
the (b) calculates the road damage from the carrying load acquired from the carrying load meter using the following Equation (1C), and the (c) calculates the accumulated road damage using the following Equation (2C),
road damage=(carrying load\hat{ }a)*coefficient (1C)
accumulated road damage=Σroad damage=Σ((carrying load\hat{ }a)*coefficient) (2C)
(in Equations (1C) and (2C), a constant a is a value for calculating damage applied to the road by the carrying load, and a coefficient is a value affecting the road damage and at least one of an environment coefficient based on temperature and/or humidity, an age coefficient based on aging of the road, a structure coefficient based on a construction structure of the road, and a material coefficient based on a material of the road).

18. The road damage calculation method according to claim 12, wherein
the load in the (a) is the load detected from a vehicle passing through an ETC lane of ETC2.0, and
the (b) and the (c) track a vehicle of which the load has been detected on the basis of traveling history data by ETC2.0 to calculate the road damage and the accumulated road damage of the road other than the ETC lane.

19. The road damage calculation method according to claim 12, further comprising:
(d) estimating a road life using the following Equation (3),
road life=(allowable total road damage amount−accumulated road damage)/road damage per predetermined period (3).

20. The road damage calculation method according to claim 19, wherein
the allowable total road damage amount is a value determined on the basis of a construction structure and/or a material of the road.

21. The road damage calculation method according to claim 19, further comprising:
(e) outputting an alarm when the accumulated road damage exceeds the allowable total road damage amount.

22. The road damage calculation method according to claim 19, further comprising:
(f) forming a repair plan of the road or corrects an existing repair plan on the basis of the road life.

23. A non-transitory recording medium storing a computer readable program for causing a computer to perform a road damage calculation method including:
(a) obtaining a load applied to a road from a vehicle on the road;
(b) calculating road damage from the detected load; and
(c) accumulating the calculated road damage to calculate accumulated road damage.
